(19) United States
(12) Patent Application Publication
(10) Pub. No.: US 2006/0047029 A1
(43) Pub. Date: Mar. 2, 2006

(54) Additive package comprising optical brighteners

(76) Inventors: Anthony Poloso, Praireville, LA (US); Ajit V. Pendse, Baton Rouge, LA (US); Robert M. Canright, Prairieville, LA (US)

Correspondence Address: ExxonMobil Chemical Company;Law Technology, P.O. Box 2149, Baytown, TX, 77522-2149, US

(21) Appl. No.: 10/929,004

(22) Filed: Aug. 27, 2004

(51) Int. Cl. C08K 5/34; C08K 5/51

(52) U.S. Cl. 524/86; 524/128; 524/386; 524/432

(57) ABSTRACT

The color or whiteness of polyolefin resins is significantly improved by the addition of low levels of optical brighteners. These brighteners can be used with standard additive packages comprising primary and/or secondary antioxidants such as phenolics and phosphites.

### FIELD OF THE INVENTION

The invention relates to the improvement of resin color by the addition of an additive package comprising antioxidants and low levels of optical brighteners. More particularly, the invention relates to improvement in the yellowness index or Hunter b color value of polyethylenes.

### BACKGROUND OF THE INVENTION

The white areas of photographic prints and other products such as fibrous and plastic articles are often made to look whiter by incorporating optical brightening agents. Many efforts have been expended to improve the “whiteness” of such articles by providing brightening agents that are non-migrating in the plastic material where they are needed, and that are stable at the extrusion and/or molding temperature of the desired form of such material, for instance, fibers, films, sheets, pellets, shaped articles, and the like.

U.S. Pat. No. 3,449,257 discloses a composition comprising a hydrophobic polymer and adding an optical brightening agent as a finely divided powder or in a mixture with a small amount of the hydrophobic polymer prepared in advance, in the amount of 0.001 wt. % to 0.25 wt. %.

U.S. Pat. No. 4,238,384 teaches intimately blending additives such as stabilizers, antioxidants, and antistatic agents with irradiation-responsive substance, such as optical brighteners, incorporated the blend in a thermoplastic polymeric material and subjected to radiation to determine the degree of uniformity of the distribution of the additive blend.

U.S. Pat. No. 4,670,183 discloses improving the apparent whiteness of a material having a yellowish tinge due to reduced blue emission by activating a fluorescent whitening agent with one or more hydroxyalkyl (meth)acrylates.

U.S. Pat. No. 4,820,760 discusses the problem of plateout on the surface of a mold or shaping apparatus, and provides a composition including a thermoplastic resin, a fluorescent pigment, a metal salt or complex, and a polymer or oligomer reagent containing a reactive functionality such as a hydroxy group.

U.S. Pat. No. 5,053,444 teaches a masterbatch comprising polymer, particulate solid, and 15 to 80 wt. % of an additive such polyalkylene glycols.

U.S. Pat. No. 6,565,987 is directed to optical brighteners for decreasing the apparent yellowness of polymeric materials, particularly polyethylene.

Additional patents of interest include U.S. Pat. Nos. 5,846,607; 6,362,258; 6,492,032; U.S. Pat. Application No. 2004/0043147; WO 0170869A2; and EP 0 889 073 A1.

Certain polyolefins, particularly polyethylene, more particularly high density polyethylene (HDPE) and most especially HDPE produced using a slurry loop process, such as those described in U.S. Pat. Nos. 6,204,344; 6,281,300; 6,319,997; and 6,380,325; 6,534,603; and 6,670,431; when formed into large articles by blow molding or injection molding processes, often possess a tinge of yellowness which is not readily cured or masked by addition of pigments and/or compounding of standard additive packages. A new additive formulation is needed which will make these resins competitive if not superior to resins produced by other processes.

The present inventors have surprisingly discovered that intimately mixing a composition comprising a primary and secondary antioxidant and a small amount of an optical brightener provides an additive package suitable for mixing with a polyolefin to provide a product having improved apparent whiteness.

### SUMMARY OF THE INVENTION

The invention is directed to an additive package (“addpack”) comprising at least one primary antioxidant and at least one secondary antioxidant and at least one optical brightener. In particularly advantageous embodiments, the composition further comprises additional ingredients including one or more lubricants and/or catalyst neutralizers.

In an embodiment, the invention is directed to a masterbatch comprising the addpack according to the present invention, and mixtures of one or more polyolefins. Particularly preferred polyolefins are ethylene polymers and copolymers (polyethylenes). Particularly preferred polyethylenes are high density polyethylenes (HDPE). Particularly preferred HDPEs are those produced in a slurry loop process.

In an embodiment, the invention is also directed to a mixture comprising one or both of the aforementioned addpack and/or masterbatch with additional polyolefin, preferably polyolefins selected from polyethylenes, more preferably HDPEs, and still more preferably HDPEs produced by a slurry loop process.

In still further embodiments, the invention relates to pellets comprising the aforementioned compositions, to articles made therefrom, and to a process for making said compositions and articles. Particularly preferred are 15 to 55 gallon drums, IBC (Intermediate Bulk Containers), and thermoformed sheets.

It is an object of the present invention to provide for the aforementioned embodiments related to compositions, processes, and articles.

It is another object of the invention to provide an addpack that will reduce yellowness in compositions and articles comprising polyolefins, particularly polyethylenes, more particularly HDPE, and still more particularly HDPE produced by a slurry loop process.

It is still another object of the invention to provide pellets comprising polyolefins, particularly polyethylenes, more particularly HDPE, and still more particularly HDPE produced by a slurry loop process.

It is yet still another object of the invention to provide for articles made from compositions according to the present invention, particularly large articles such as durable goods, drums, and packaging materials, and also articles, especially large articles made by injection molding processes or blow molding processes.

These and other embodiments, objects, features, and advantages will become apparent as reference is made to the following detailed description, preferred embodiments, examples, and appended claims.

### DETAILED DESCRIPTION

According to the invention, an addpack is provided comprising one or more optical brighteners, one or more primary antioxidants, and one or more secondary antioxidants.

In an embodiment, the one or more optical brighteners may be selected from those identified as optical brighteners in the prior art, such as the patents set forth in the background section above and those references cited therein. Optical brighteners particularly useful in the present invention are materials which fluoresce upon irradiation with UV light, emitting visible light, more preferably visible light bluish in hue to compensate for a yellow cast which may be produced by the polyolefin. Thus, more preferred classes of optical brighteners are those having an absorption in the UV and an emission in the visible spectrum as blue light. It is also preferred that the optical brightener(s) have stability to thermal molding processes, e.g., injection molding or blow molding processes. Such process temperatures may be as high as about 330° C. or even higher. For certain applications, such as food packaging, it is still more preferred that the optical brightener selected be approved by any governmental body approving ingredients for such applications, e.g., the Food and Drug Administration (FDA) in the United States.

Examples of optical brighteners that are useful in the present invention include fluorescent thiophenes and stilbenes, which may be substituted or unsubstituted. Particularly preferred substituents are those comprising the benzoxazolyl moiety. Preferred commercially available optical brighteners include Uvitex OB™ and Uvitex OB-1™, available from Ciba Specialty Chemicals.

The amount of optical brightener in the addpack will preferably be that amount necessary to give the concentration of the optical brightener in the final polymer of about 1 to about 20 ppm, more preferably about 2 to about 15 ppm, and still more preferably about 4 to about 10 ppm, with ranges from any lower amount specified herein to any higher amount specified herein also being contemplated as preferred embodiments, e.g., about 1 to about 15 ppm, about 4 to about 20 ppm, about 2 to about 10 ppm, and so on.

The addpack composition according to the present invention also includes one or more primary antioxidants and one or more secondary antioxidants.

Primary antioxidants, or primary stabilizers as they are often called, means an ingredient which functions as a radical scavenger in the resin. Quinones and stable free radicals that can act as alkyl radical trapping agents are good examples of primary antioxidants. The particular choice of primary antioxidant will depend on the level of oxidizability of the base polymer, the extrusion or molding temperature, and the performance target of the end-use application. Preferred primary antioxidants for use with polyolefins are stearically hindered phenols, particularly the per se well known and commercially available hindered phenolics such as Ethanox™ 314 available from Albemarle, Irganox™ 1010, and Irganox™ 1076, available from Ciba Specialty Chemicals.

In the case where the resin mixture comprises polyolefin, the amount of primary antioxidant in the addpack is preferably that amount necessary to give the concentration of the primary antioxidant in the final polymer mixture of about 200 to about 1000 ppm, more preferably 250 to about 600 ppm, still more preferably about 300 to about 500 ppm, yet still more preferably about 350 to about 450 ppm, with ranges from any lower amount specified herein to any higher amount specified herein also being contemplated as preferred embodiments, e.g., about about 300 to about 1000 ppm, about 250 ppm to about 450 ppm, about 350 to about 600 ppm, and so on.

Secondary antioxidants, or preventive antioxidants as they are often called, means an ingredient which provides a protection mechanism against peroxides and hydroperoxides that would otherwise react in a detrimental way with the resin and produce undesirable changes in melt viscosity and color formation. Phosphorus compounds, e.g., phosphites, and sulfur-containing compounds, e.g, thioproprionate esters, are preferred secondary antioxidants. Particularly preferred are the phosphorus-containing secondary antioxidants, many of which are commercially available such as IRGAFOS™ 168 from Ciba Specialty Chemicals, ULTRANOX™ 626 from Crompton, and DOVERPHOS™ 9228 from Dover Chemical.

In the case where the resin mixture comprises polyolefin, the amount of secondary antioxidant in the addpack is preferably that amount necessary to give the concentration of the secondary antioxidant in the final polymer of about 200 to about 1500 ppm, more preferably 250 to about 600 ppm, still more preferably about 300 to about 500 ppm, yet still more preferably about 350 to about 450 ppm, with ranges from any lower amount specified herein to any higher amount specified herein also being contemplated as preferred embodiments, e.g., about 300 ppm to about 1500 ppm, or about 250 ppm to about 450 ppm, or about 350 to about 600 ppm, and so on.

While the amount of primary antioxidant can be selected independent of the amount of secondary antioxidant, in certain embodiments it may be beneficial to have the weight ratio of primary to secondary antioxidants be in the range of about 1:2 to about 2:1, more preferably from about 2:3 to about 3:2, still more preferably from about 3:4 to about 4:3, and yet still more preferably about 1:1, with ranges from any lower ratio to any higher ratio being contemplated, e.g., about 1:2 to about 4:3, or about 3:4 to about 2:1, and so on.

A particularly beneficial but optional ingredient in the addpack include one or more lubricants such as zinc stearate, calcium stearate, and other fatty acid metal soaps, metal oxides, especially divalent metal oxides such as zinc oxide and magnesium oxide, hydrotalcites such as those available commercially from Kyowa Chemical under the trademarks DHT-4A, DHT-4C and DHT-4V, and also fluorocarbons, and mixtures thereof, or catalyst neutralizers such as glycerol, polyethylene glycol, and mixtures thereof, particularly when the polyolefin catalyst is chromium or a titanated chrome catalyst. It is preferred that when polyethylene glycol is used that the number average molecular weight of the polyethylene glycol is about 1,000 or less.

Broadly, the term lubricant as used herein means an ingredient acting as a mold release agent or a processing aid to plasticize the resin. The term catalyst neutralizer broadly means that the ingredient complexes in some manner with the catalyst. However, it will be recognized by one of ordinary skill in the art in possession of the present disclosure that in some cases a catalyst neutralizer and a lubricant can serve the same function. For instance, zinc stearate can act as a catalyst neutralizer with respect to a Zeigler-Natta catalyst, and yet in other contexts zinc stearate has the soapy characteristics of a lubricant. Likewise, when a chrome catalyst is used in making the resin, glycerol or PEG is used to bond to the catalyst to prevent the formation of color bodies, such as quinones, and yet in other contexts PEG can be used as a lubricant. Accordingly, it will be understood that the terms catalyst neutralizer and lubricant should be taken within the context of the catalyst used in the process to make the polyolefin.

In the case where at least one lubricant such as a metal soap, divalent metal oxide, hydrotalcite, or fluorocarbon is used, it preferably should be present in the addpack in an amount necessary to provide in the final polymer mixture lubricant in the amount of about 100 to about 300 ppm, more preferably about 150 to about 250 ppm, with ranges from about 100 to about 250 ppm and about 150 to about 300 ppm also contemplated. It is preferred that the weight ratio of lubricant to the total amount of primary and secondary antioxidants used be in the range of about 1:3 to about 5:1. In the most preferred embodiment the lubricant is present in the addpack in a ratio of primary antioxidant to secondary antioxidant to lubricant of about 2:2:1.

In the case where at least one catalyst neutralizer such as glycerol is used it preferably should be present in the addpack in an amount necessary to provide in the final polymer mixture catalyst neutralizer in the amount of about 50 to about 200 ppm, more preferably about 75 to about 150 ppm, with ranges from about 50 to about 150 ppm and about 75 to about 200 ppm also contemplated. In the case where a catalyst neutralizer is present in the addpack, in a preferred embodiment, the neutralizer is present in the addpack in a weight ratio of primary antioxidant to secondary antioxidant to catalyst neutralizer of about 4:4:1.

The addpack mixture may be premixed or blended, with or without the addition of a small amount of resin, prior to addition to the polymer, so that it is an intimate mixture, and preferably having a predetermined mesh size, or the ingredients may be added separately to the resin and blended before being added to the extruder. The components in the addpack may be dry-blended, melt blended, or dissolved together in a solvent followed by removal of the solvent by evaporation, or a combination thereof. These methods are per se known and routine, such as set forth in the above-mentioned U.S. Pat. No. 4,238,384.

The polymers in which the additive package are incorporated may include any thermoplastic organic polymer, e.g., polyamides, polyurethanes, polyacrylates, ABS copolymers, polystyrenes, polycarbonates, polyvinyl chlorine, polyesters, synthetic rubber, and polyolefins. Preferred polyolefins include polyethylene and polypropylene, including isotactic, atactic, and syndiotactic polypropylene. Particularly preferred polyolefins are ethylene polymers and copolymers, i.e., polyethylene.

Polyethylene generally may also be characterized as a homopolymer or copolymers of ethylene. Polymers comprising ethylene and having more than two types of monomers, such as terpolymers, are also included within the term “copolymer” as used herein.

Various types of polyethylenes are known in the art. For the purposes of the present invention, the following descriptions of polyethylenes apply. Low density polyethylene (“LDPE”) can be prepared at high pressure using free radical initiators and typically has a density in the range of 0.916-0.940 g/cm³. LDPE is also known as “branched” or “heterogeneously branched” polyethylene because of the relatively large number of long chain branches extending from the main polymer backbone. Polyethylene in the same density range, i.e., 0.916 to 0.940 g/cm³, which is linear and does not contain large quantities of long chain branching is also known; this “linear low density polyethylene” (“LLDPE”) can be produced with conventional Ziegler-Natta catalysts or with single site catalysts, such as metallocene catalysts, discussed further below. Relatively higher density LDPE or LLDPE, typically in the range of 0.928 to 0.940 g/cm³ are sometimes referred to as medium density polyethylene (“MDPE”) or Linear Medium Density Polyethylene (LMDPE), respectively. Polyethylenes having still greater density are the high density polyethylenes (“HDPEs”), i.e., polyethylenes having densities greater than 0.940 g/cm³, and are generally prepared with Ziegler-Natta catalysts, chrome catalysts or even single site catalysts such as metallocene catalysts. Very low density polyethylene (“VLDPE”) is also known. VLDPEs can be produced by a number of different processes yielding polymers with different properties, but can be generally described as polyethylenes having a density less than 0.916 g/cm³, typically 0.890 to 0.915 g/cm³ or 0.900 to 0.915 g/cm³. VLDPEs produced using metallocene or other single-site catalysts, as discussed further below, are referred to as a type of plastomer. Plastomers having a density as low as 0.860 g/cm³ are commercially available. LLDPE and VLDPE produced using metallocene catalysts which are useful in the present invention are referred to herein as mLLDPE and mVLDPE, respectively. Densities as used herein are those measured using ASTM D-1505.

Metallocene catalysts are per se well-known in the art. Included within the definition of the “metallocene polyethylene” useful in the present invention are polyethylene resins having a low polydispersity as described, for instance, in U.S. Pat. No. 6,492,010, that is, a polydispersity produced by a catalyst variously described as “single site”, “constrained geometry”, or the aforementioned metallocene catalyst, catalysts per se well known in the prior art.

Metallocene or low polydispersity resins useful in the present invention are available from, among others, Dow Chemical Company and ExxonMobil Chemical Company who are producers of single site or constrained geometry catalyzed polyethylenes. These resins are commercially available as the ENHANCED POLYETHYLENE™, ELITE™, AFFINITY™, EXXACT™, and EXCEED™ polyethylene resins. TAFMER™ resins, available from Mitsui Chemical Company and also having low polydispersity, also useful in present invention, and are included within the definition of the term “metallocene polyethylene” for the purposes of the present invention.

The comonomers that are useful in the present invention include alpha-olefins, such as C₃-C₂₀ alpha-olefin and preferably C₃-C₁₂ alpha-olefins. The alpha-olefin comonomer can be linear or branched, and two or more comonomers can be used, if desired. Examples of suitable comonomers include linear C₃-C₁₂ alpha-olefins, and alpha-olefins having one or more C₁-C₃ alkyl branches, or an aryl group. Specific examples include propylene; 3-methyl-1-butene; 3,3-dimethyl-1-butene; 1-pentene; 1-butene; 1-pentene with one or more methyl, ethyl or propyl substituents; 1-hexene; 1-hexene with one or more methyl, ethyl or propyl substituents; 1-heptene with one or more methyl, ethyl or propyl substituents; 1-decene; 1-dodecene; 1-octene with one or more methyl, ethyl or propyl substituents; 1-nonene with one or more methyl, ethyl or propyl substituents; ethyl, methyl or dimethyl-substituted 1-decene; 1-dodecene; and styrene. It should be appreciated that the list of comonomers above is merely exemplary, and is not intended to be limiting.

Polyethylene useful in the present invention may be that produced by any process, e.g., slurry, solution, or gas phase processes. The advantages of the present invention are particularly seen in HDPE produced by the slurry process using Ziegler-Natta or chromium based catalysts. An example is a drum-grade HDPE copolymer LA-439 from ExxonMobil Chemical Company, having a density of 0.953 g/cc and an HLMI of 5.5. HLMI as used herein refers to High Load Melt Index measured at 21.6 kg, as measured according to ASTM D-1238 FR 190/21.6.

The addpack is incorporated in the polymer material in the same manner in which the addpack ingredients are mixed. Preferably the intimate mixture of addpack ingredients and the polymer, also in solid particulate form, are dry blended and then rendered molten and molded into a desired shape, e.g., pellets or final shaped article. Pelletization of polyolefins per se is well-known in the art, e.g., see U.S. Pat. No. 6,474,969. It is preferred that the ingredients for the resin composition to be pelletized may be blended using conventional equipment and methods, such a by dry blending the individual components and subsequently melt mixing in a mixer, or by mixing the components together directly in a mixer, such as a Banbury mixer, a Haake mixer, a Brabender internal mixer, Kobe or Farrel continuous mixers, or a single or twin-screw extruder including a compounding extruder and a side-arm extruder used directly or indirectly downstream of a polymerization process. The composition may then be extruded into pellets, for instance by using an underwater pelletizer as set forth in the aforementioned U.S. Patent.

In another preferred embodiment the intimate mixture of additives is compounded into the resin using twin screw extruders when the polyethylene is pelletized. In still another preferred embodiment, there is a pelletized additive blend containing all the components. In yet another preferred embodiment a masterbatch comprising addpack and polymer is let down with additional resin while compounding using a twin screw extruder and pelletized. The pellets are then used in the final process, e.g., thermoformed or otherwise molded or extruded into a product, such as a film, sheet, or other article.

The amount of addpack employed will be that amount necessary to give the concentration of additive in the polymer which would normally be used if the additive were being added in its conventional form, e.g., each ingredient added separately to the polymer. That amount will depend on whether it is desired to achieve the final concentration immediately or to produce an addpack-polymer concentrate, e.g., masterbatch, which can be let down or diluted later with more polymer. Preferred quantities of the addpack ingredients have been set forth above.

The present invention provides a composition and an additive package comprising said composition useful in polyolefins, particularly polyolefins used in extrusion and molding applications, and in the making of films and sheets. As examples, which are not meant to be limiting, the present invention is useful in polyolefins used in cast or tubular blown films, thin films, extrusion coated paper, paperboard, photographic paper, digital and thermal imaging papers, diaper backing. Even more preferably, it is useful in polyolefins used for plastic substrates, injection molded, compression molded, or blow molded objects, and packaging applications, such as coatings on soap boxes, milk cartons, fruit juice cartons, and the like. The greatest benefit in the reduction of yellowness is in thick parts comprising polyolefins, e.g., articles made by blow molding, injection molding (especially packaging applications), durable goods, drums, and the like. Yet even more preferable are thermoformed sheets, 15-50 gallon drums, and blow molded IBC (Intermediate Bulk Containers), e.g., IBCs having a volume of about 400 gallons. Furthermore, in a preferred embodiment of the aforementioned uses, the polyolefin is polyethylene, more preferably HDPE and even more preferably HDPE produced by a slurry loop process and/or oxygen-tailored polyethylene.

The following examples are intended to illustrate the invention and comparative results with particular detail. Numerous modifications and variations are possible, and it is to be understood that within the scope of the appended claims, the invention may be practiced otherwise than as specifically described herein.

Hunter b color values (sometimes referred to as Hunter B color values) are obtained on lots produced using the compositions specified below on a BYK Gardener Colorometer and Data Terminal, following standard Hunter b color values on pelletized resin. Such colorimeters and the procedures to obtain the color values are well-known per se in the art. See for instance U.S. Pat. No. 3,972,854 and references discussed therein.

### EXAMPLE 1 (COMPARATIVE)

An HDPE produced by a slurry loop process, BA50-100, a 10 HLMI, 0.950 g/cc density resin, commercially available from ExxonMobil Chemical Company, is used as the base resin. Various amounts of commercially available primary antioxidants and lubricants and/or catalyst neutralizers are intimately mixed and compounded with the HDPE in a twin screw extruder to be pelletized and the Hunter b color values obtained. Typically, Hunter b values equal to about 3 or higher are achieved. In the best case, using 1200 ppm Irganox™ 1010 from Ciba Specialty Chemicals, and 200 ppm zinc stearate, a Hunter b value of 2.1 was achieved.

### EXAMPLE 2 (COMPARATIVE)

In the same manner as above, the Hunter b color value obtained from a pelletized mixture comprising the same HDPE, 1200 ppm Irganox™ 1010, 200 ppm zinc stearate, and 10 ppm Uvitex OB™ optical brightener, was about 1.5.

### EXAMPLE 3 (COMPARATIVE)

In the same manner as above, the Hunter b color value obtained from a mixture comprising the same HDPE, 200 ppm Irganox™ 3114, 400 ppm Irgaphos™ 168, 200 ppm zinc stearate, and 100 ppm glycerol, was about 0.75.

### EXAMPLE 4 (COMPARATIVE)

Resin is compound in the same manner as in the previous examples using an intimately mixed addpack consisting of 240 ppm Irganox™ 3114, 240 ppm Irgaphos™ 368, 480 ppm zinc stearate, and 120 ppm glycerol. The color of the lots produced averaged 0.5.

### EXAMPLE 5

In the same manner as above, the Hunter b color value obtained from a mixture comprising the HDPE, 200 ppm Irganox™ 3114, 400 ppm Irgaphos™ 168, 200 ppm zinc stearate, 100 ppm glycerol, and 10 ppm Uvitex OB™, is about −0.5.

### EXAMPLE 6

Resin is compounded in the same manner as in the previous examples using an intimately mixed addpack consisting of 400 ppm Irganox™ 3114, 400 ppm Irgaphos™ 368, 200 ppm zinc stearate, 100 μm glycerol, and 10 ppm Uvitex OB-1™. The color of the lots produced average −2.5.

### EXAMPLES 7-17

Resin as identified below is compounded in the same manner as in the previous examples using an intimately mixed addpack consisting of the ingredients set forth in Table 1 to provide pellets. Each row corresponds to an example. The first five examples are illustrative of compositions according to the present invention, and the remainder are comparative examples.

TABLE 1
(all units given in ppm, by weight)

| | | | Primary | | | Secondary Antioxidants | | | | | | | |
|---|---|---|---|---|---|---|---|---|---|---|---|---|---|
| | Optical | | Antioxidants | | | (Phosphites) | | | | Lubricant and/or | | | |
| | Brighteners | | | | Irg | | | Doverphos | Ultranox | neutralizer | | | Color B |
| resin | OB-1 | OB | E-314 | I-3114 | 1010 | E-368 | I-168 | 9228 | 626 | ZnSt | Glycerol | Carbowax | value |
| LA448 | 6.5 | — | 520 | — | — | 520 | — | — | — | 260 | 130 | — | −1.4 |
| LA448 | 10 | — | 400 | — | — | 400 | — | — | — | 200 | 100 | — | −2.2 |
| LA439 | — | 6.5 | 520 | — | — | 520 | — | — | — | 259.8 | 129.2 | — | −1.2 |
| LA451 | — | 6.5 | 520 | — | — | 520 | — | — | — | 259.8 | 129.2 | — | −1.9 |
| LA450 | — | 13 | 520 | — | — | 520 | — | — | — | 260 | 130 | — | −1.7 |
| LA439 | — | — | — | 244 | — | — | 489 | — | — | 244 | 122 | — | 0.8 |
| LA439 | — | — | — | — | 450 | — | 900 | — | — | — | — | 0.11 | 0.1 |
| LA439 | — | — | — | — | 450 | — | — | 700 | — | — | — | 0.11 | 0.1 |
| LA439 | — | — | — | — | 525 | — | — | 525 | 525 | 420 | — | — | 2.0 |
| LA439 | — | — | — | — | 525 | — | — | 525 | 525 | 420 | — | — | 1.5 |
| LA439 | — | — | — | — | 525 | — | — | 525 | 525 | 420 | — | — | 1.7 |

OB-1 - Uvitex OB-1 from Ciba
OB - Uvitex OB from Ciba
E-314 - Ethanox 314 from Albemarle
I-3114 - Irganox 3114 from Ciba
Irg 1010 - Irganox 1010 from Ciba
E-368 - Ethanox 368 from Albemarle
I-168 - Irgaphos 168 from Ciba
Doverphos 9228 - from Dover Chemical
Ultranox 626 - from Crompton

The numerical values in Table 1 are in ppm by weight. The Hunter b color values are determined in the same manner as the previous Hunter b color values. The resin used is produced in a slurry loop process. The LA designation refers to a experimental grade HDPE copolymer using hexene-1 as comonomer and all were made using a commercially available titanated chrome catalyst in a slurry loop process. All the resins have a density of 0.953 g/cc and HLMI of 5.5. The number associated with each LA value serves to designate the additive package, which is set forth in the table.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains. Many variations will suggest themselves to those skilled in this art in light of the above detailed description. All such obvious variations are within the full intended scope of the appended claims.

Trade names used herein are indicated by a ™ symbol or ® symbol, indicating that the names may be protected by certain trademark rights, e.g., they may be registered trademarks in various jurisdictions. Parts per million used herein are on a weight basis. All patents and patent applications, test procedures (such as ASTM methods, UL methods, and the like), and other documents cited herein are fully incorporated by reference to the extent such disclosure is not inconsistent with this invention and for all jurisdictions in which such incorporation is permitted. When numerical lower limits and numerical upper limits are listed herein, ranges from any lower limit to any upper limit are contemplated.

What is claimed is:

1. A composition comprising a primary antioxidant, a secondary antioxidant, at least one ingredient selected from lubricants, catalyst neutralizers, and mixtures thereof, and an optical brightener.

2. The composition of claim 1, further comprising a polyolefin resin.

3. The composition of claim 1, further comprising polyethylene resin.

4. The composition of claim 1, further comprising HDPE produced in a slurry loop process.

5. The composition of claim 1, wherein said at least one primary antioxidant is a stearically hindered phenol.

6. The composition of claim 1, wherein said at least one secondary antioxidant is a phosphite.

7. The composition of claim 1, comprising at least one of the following: a lubricant in the amount of about 100 to about 300 ppm; a catalyst neutralizer in the amount of about 50 to about 200 ppm.

8. The composition of claim 1, comprising an ingredient selected from fatty acid metal soaps, divalent metal oxides, hydrotalcites, and mixtures thereof.

9. The composition of claim 1, comprising an ingredient selected from glycerol, polyethylene glycol, and mixtures thereof.

10. The composition of claim 9, wherein said polyethylene glycol has a number average molecular weight of about 1,000 or less.

11. The composition of claim 1, wherein said optical brightener is present in the amount of from about 1 to about 20 ppm.

12. The composition of claim 1, wherein said primary antioxidant is at least one hindered phenol, said primary antioxidant present in the amount of from about 200 to about 1000 ppm.

13. The composition of claim 12, wherein said primary antioxidant is present in the amount of from about 300 to about 600 ppm.

14. The composition of claim 1, wherein said secondary antioxidant is least one phosphite, said secondary antioxidant present in the amount of from about 200 to about 1500 ppm.

15. The composition of claim 14, wherein said secondary antioxidant is present in the amount of from about 300 to about 600 ppm.

16. A pelletized additive blend comprising resin and the composition according to claim 1.

17. The pelletized additive blend of claim 16, wherein said resin is HDPE produced in a slurry loop process.

18. A masterbatch comprising the composition of claim 1 and polyethylene.

19. A composition comprising HDPE and the composition of claim 1 and having a Hunter b color value of less than 0.

20. A plastic article produced by a thermoforming or molding process and comprising the composition according to claim 19.

21. The plastic article according to claim 20, wherein said process is selected from blow molding, injection molding, compression molding, and rotomolding.

22. The plastic article according to claim 20, wherein said article comprises a blown or cast film.

23. The plastic article according to claim 20, wherein said article is a 15-55 gallon drum, a blow molded IBC, or a thermoformed sheet.

24. A composition comprising HDPE, a primary antioxidant, a secondary antioxidant, an optical brightener, and at least one ingredient selected from lubricants, catalyst neutralizers, and mixtures thereof.

25. The composition according to claim 24, wherein said HDPE is from a slurry loop process.

26. The composition of claim 24, wherein said primary antioxidant is at least one hindered phenol, said primary antioxidant present in the amount of from about 200 to about 1000 ppm.

27. The composition of claim 26, wherein said primary antioxidant is present in the amount of from about 300 to about 600 ppm.

28. The composition of claim 24, wherein said secondary antioxidant is at least one phosphite, said secondary antioxidant present in the amount of from about 200 to about 1500 ppm.

29. The composition of claim 28, wherein said secondary antioxidant is present in the amount of from about 300 to about 600 ppm.

30. The composition of claim 24, further comprising at least one of the following: a lubricant selected from zinc stearate, zinc oxide, and mixtures thereof in the amount of about 100 to about 300 ppm, and a catalyst neutralizer selected from glycerol, polyethylene glycol having a number average molecular weight of about 1,000 or less, and mixtures thereof in the amount of about 50 to about 200 ppm.

31. The composition according to claim 30, wherein said HDPE is produced in a slurry loop process using a catalyst comprising chromium, further comprising at least one primary antioxidant selected from hindered phenols, said primary antioxidant present in the amount of about 300 to about 600 ppm, at least one secondary antioxidant selected from phosphites, said secondary antioxidant present in the amount of about 300 to about 600 ppm, a lubricant selected from fatty acid metal soaps, divalent metal oxides, hydrotalcites, and mixtures thereof in the amount of about 100 to about 300 ppm, and a catalyst neutralizer selected from glycerol, polyethylene glycol having a number average molecular weight of about 1,000 or less, and mixtures thereof in the amount of about 50 to about 200 ppm.

32. The composition according to claim 31, wherein said lubricant is selected from stearate salts, zinc oxide, magnesium oxide, hydrotalcites, and mixtures thereof.
